(19) United States
(12) Patent Application Publication
(10) Pub. No.: US 2013/0080182 A1
(43) Pub. Date: Mar. 28, 2013

(54) Methods For Using DNA Testing To Screen For Genotypes Relevant To Athleticism, Health And Risk Of Injury

(71) Applicant: James J. Kovach, Larkspur, CA (US)

(72) Inventor: James J. Kovach, Larkspur, CA (US)

(73) Assignee: Athleticode Inc.

(21) Appl. No.: 13/245,093

(22) Filed: Sep. 26, 2011

(51) Int. Cl. G06Q 50/22

(52) U.S. Cl. 705/2

(57) ABSTRACT

Genetic screening is described which allows for the identification of athletes predisposed to physical conditions that could affect their performance. This, in turn, allows for associated personnel such as trainers, strength/conditioning coaches, and physicians, to develop pre-habilitation strategies that are personalized for the athlete's genetic and corresponding physical makeup.

### FIELD OF THE INVENTION

The present invention relates to screening and identification of gene variations associated with elite athletic ability, athletic performance, and predispositions to injury or disease.

### BACKGROUND OF THE INVENTION

There are a variety of factors which can contribute to the overall performance and capabilities of an elite athlete. These factors can be divided into two categories: environment and genetics. The environmental factors contributing to elite athletic performance have been examined and have produced generic training and diet regiments. Although these are beneficial, understanding of individual genetics would undoubtedly improve the identification of potential strengths and weaknesses. However, there has been no ability until recently to probe genetics of athletes on broad basis.

### SUMMARY OF THE INVENTION

The Human Genome Project completed in 2000 took 10 years at a cost of $3 billion to sequence the first human genome. Over the next ten years, High Throughput DNA sequencing created ability to compare genes between individuals on a broad basis. Currently, Genome Wide Association Studies (GWAS) allow comparison of gene variations between study groups [1]. GWAS to date has been used to identify gene variations associated with the predisposition to disease.

The present invention relates to screening and identification of gene variations associated with elite athletic ability, athletic performance, and predispositions to injury or disease. The inventor was the first to propose and run a GWAS comprised solely of professional athletes in order to identify genes associated with strength, size and other physiological attributes associated with athleticism—this study was published in ESPN and relied on 100 former NFL offensive linemen [2]. While no gene variations were present in NFL players compared to non-players (perhaps do to the size of the study and/or the number of variants screened), the conception of using cohorts of athletes to compare versus non-athletes to identify gene variations associated with athleticism is believed to be novel and should identify useful variations associated with performance, overall health, and risk of injury.

In one embodiment, the present invention contemplates gene discovery, which involves comparisons of athletic populations to non-athletic populations (or comparisons of professional athletic populations to non-professional athletic populations) and using standard bioinformatic methodologies to identify which gene variations are statistically more likely to occur in athletes when compared to non-athletic populations. In one embodiment, the present invention contemplates a method for identifying genes comprising: a) a first population of athletes with a particular injury; and b) a second population of athletes that did not have said injury; c) comparing said populations in a Genome-wide association study (GWAS). In one embodiment, said first and second populations played the same high school, college and/or professional sport (e.g. football, soccer, hockey, etc.). In one embodiment, the members of said first and second population played the same professional sport for at least 5 years, and preferably 10 years or more. In one embodiment, the members of said first and second population are of the same sex.

There are many studies that have analyzed the presence of specific genes associated with athleticism in athletic populations; however the utilization of genome wide association studies in specifically targeted athletic populations in order to discover new gene variants is believed to be novel. The scientific basis for the invention is predicated on the observation that the physiological selection required to withstand competition and successfully make the roster of a professional team is based in part on genetic variations in genes underlying athletic performance. Further, these genes should be identifiable if the entire genome of a suitably large and homogeneous population of athletes is compared to non-athletes using standard bioinformatic methodologies which to date have been deployed only to identify gene variations associated with diseases.

Examples of genes which would be representative of the kinds underlying athleticism would relate to functions such as respiration, glucose metabolism, tissue repair, acclimation (response to training) and bone strength, all which correlate to physiological responses required to succeed in elite athletics.

Genetic screening allows for the identification of athletes predisposed to physical conditions that could affect their performance. This, in turn, allows for associated personnel such as trainers, strength/conditioning coaches, and physicians, to develop pre-habilitation strategies that are personalized for the athlete's genetic and corresponding physical makeup

The present invention includes the method of genetic screening to comprehensively identify genes affecting various aspects of athletic play, including: (1) predisposition to injury, (2) human performance, (3) salt retention and fluid status (4) medical conditions affecting athletic performance.

With respect to injury, the present invention contemplates in one embodiment, a method for conditioning an athlete, said method comprising: a) determining the genotype of said athlete for at least one gene associated with a predisposition to injury; and b) preparing a pre-habilitation regimen, wherein the pre-habilitation regimen is selected based on the determined genotype. In one embodiment, the determined genotype is based upon the COL5A1 gene associated with ACL rupture. In one embodiment, the determined genotype is based upon the COL1A1 gene associated with ACL rupture. In one embodiment, the determined genotype is based upon the COL12A1 gene associated with ACL rupture. In one embodiment, the determined genotype is based upon the genes from the Matrix metalloproteinase (MMP) gene family which is associated with Achilles tendinopathy. In one embodiment, said MMP gene is MMP3. In one embodiment, the determined genotype is based upon a combination of genes from the Matrix metalloproteinase (MMP) gene family and the COL5A1 gene which are associated with Achilles tendinopathy. In one embodiment, the determined genotype is based upon the INC gene which is associated with Achilles tendon injury. In one embodiment, the determined genotype is based upon the APOE gene associated with deleterious effects of head trauma. In one embodiment, said APOE gene is ApoE4. In one embodiment, said APOE gene is ApoE2.

With respect to human performance, the present invention contemplates, in one embodiment a method for conditioning an athlete, said method comprising: a) determining the genotype of said athlete for at least one gene associated with a predisposition to athletic performance; and b) preparing a pre-habilitation regimen, wherein the pre-habilitation regimen is selected based on the determined genotype. In one embodiment, said athletic performance is selected from the group: strength, power, endurance, muscle fiber size and composition, flexibility, neuromuscular coordination, temperament, and metabolism. In one embodiment, the determined genotype is based upon the Actn3 gene associated with slow twitch muscle fibers and fast twitch muscle fibers. In one embodiment, said pre-habilitation regimen comprises plyometrics. In one embodiment, said pre-habilitation regimen comprises balancing exercises. In one embodiment, said pre-habilitation regimen comprises leg strengthening exercises. In one embodiment, said determined genotype is based upon the Angiotensin Converting Enzyme (ACE) Gene associated with lower circulating and tissue activity and lower blood pressure. In one embodiment, the Angiotensin Converting Enzyme (ACE) Gene associated with lower circulating and tissue activity and lower blood pressure is the I allele. In one embodiment, said determined genotype is based upon the BDKRB2 gene associated with endurance among elite athletes. In one embodiment, the BDKRB2 gene is the BDKRB2 −9 haplotype (B2R −9). In one embodiment, said determined genotype based upon the NOS3 gene. In one embodiment, said NOS3 gene is the wild-type GG genotype. In one embodiment, said determined genotype is based upon the ADRB2 gene. In one embodiment, the ADRB2 gene is the Arg16/Gly single nucleotide polymorphism (SNP) of the ADRB2) associated with endurance in athletes. In one embodiment, said determined genotype is based upon the AGT gene. In one embodiment, said determined genotype is based upon the AMPD1 gene. In one embodiment, the AMPD1 gene is AMPD1 C34T mutation implicated in endurance. In one embodiment, said determined genotype is based upon Mitochondrial DNA. In one embodiment, said determined genotype is based upon the pparGC1a gene. In one embodiment, the pparGC1a gene is Gly482Ser variant associated with exceptional endurance in runners. In one embodiment, said determined genotype is based upon the NRF-1 gene. In one embodiment, the NRF-1 gene is selected from polymorphisms rs2402970 and rs6949152 associated with human aerobic capacity (and its trainability) expressed as ventilatory threshold (VT) or running economy (RE). In one embodiment, said determined genotype is based upon the NRF-2 gene. In one embodiment, the NRF-2 gene combination is the ATG haplotype.

With respect to salt retention, the present invention contemplates, in one embodiment, a method for rehydrating an athlete, said method comprising: a) determining the genotype of said athlete for at least one gene associated with salt retention or salt-sensitive blood pressure; and b) administering a rehydration fluid to said athlete based on the determined genotype. In one embodiment, the determined genotype is based upon a polymorphism in a cytochrome P450 gene associated with salt retention. In one embodiment, said P450 gene is CYP3A5. In one embodiment, said P450 gene is selected from the group consisting of CYP11B1 and CYP11B2. In one embodiment, said gene associated with salt-sensitive blood pressure is the angiotensinogen gene. In one embodiment, the rehydration fluid is prepared by combining an amount of sodium with an aqueous component. In one embodiment, the amount of sodium is selected mechanically releasing a calibrated amount of sodium into an aqueous component in a drinking vessel. In one embodiment, the invention method further comprises measuring urinary sodium excretion and systolic blood pressure in said athlete.

In one embodiment, the method of obtaining genetic information comprises a relatively focused screen containing panels of 20-40 genes. In another embodiment, whole genome scans using a saliva-based test able to probe 500,000 or more single nucleotide polymorphisms simultaneously, or whole genome sequencing, are contemplated.

The three major causes of athlete death currently are: 1) sudden cardiac death, 2) Malignant heat stroke and 3) sickle cell trait induced rhabdomyolysis—each of these conditions could be detected genetically in a single assay which could take place in conjunction with annual physicals conducted on athletes. The identification of all conditions linked with athletic death, injury, and performance; and medical conditions affecting athlete health, all in a single test, will save lives and advance the field, and result in personalized training and safety regimens for the athlete.

### BRIEF DESCRIPTION OF THE DRAWINGS

For a more complete understanding of the features and advantages of the present invention, reference is now made to the detailed description of the invention along with the accompanying figures.

FIG. 1 shows noncontact ACL injuries usually occur during landing or sharp deceleration. In these cases, the knee at the time of injury is almost straight and may be associated with valgus (inward) collapse. The athlete often lands with a flat-foot position and the leg is placed in front or to the side of the trunk.

FIG. 2 shows proper landing techniques for one embodiment of re-habilitation exercises which emphasize landing on the balls of the foot with the knees flexed and the chest over the knees.

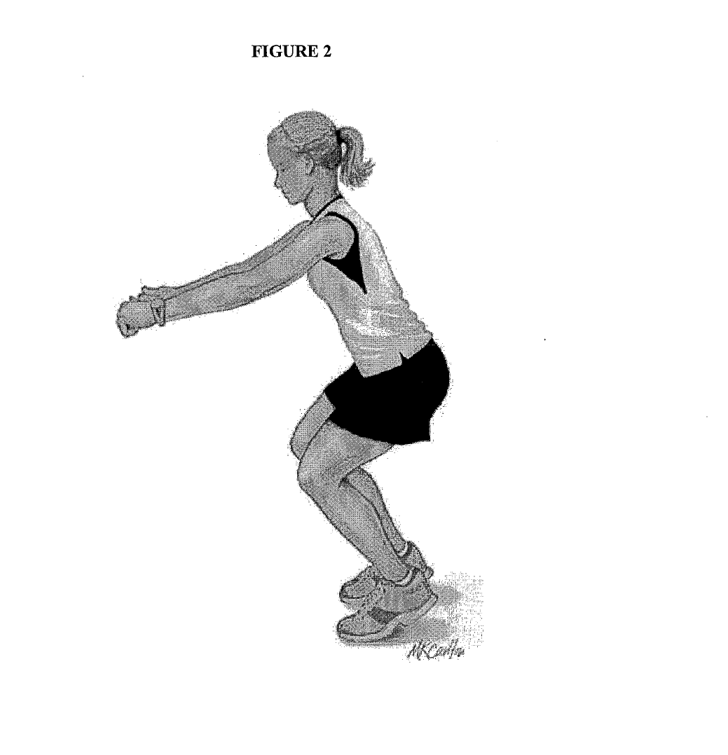

FIG. 3 shows the percent decrease in ACL injuries in 7 ACL injury prevention neuromuscular training studies. The range of effect sizes of these studies was 24% to 82% reduction, and the average decrease in risk was approximately one-half (mean, 48%) reduction in ACL injury risk with neuromuscular training. (Hewett T E et al. [3], Heidt R S Jr. et al. [4], Mandelbaum, B. [5], Soderman, K. et al. [6], Myklebust, G et al. [7], Petersen, W. et al. [8], Gilchrist, J. et al. [9])

FIG. 4 shows differences in valgus knee motion between female and male athletes when dropping off a box and progressing into a maximum vertical jump (performing a drop vertical jump maneuver). (A) Decreased dynamic valgus motion during landing in a trained or preadolescent female. (B) Increased dynamic valgus motion during landing in an untrained or mature adolescent female. (C) Decreased dynamic valgus motion in a male athlete.

### GENERAL DESCRIPTION OF THE INVENTION

The present invention relates to screening and identification of gene variations associated with elite athletic ability, athletic performance, and predispositions to injury or disease. The present invention includes the method of genetic screening to comprehensively identify genes affecting various aspects of athletic play, including: (1) predisposition to injury, (2) human performance, (3) salt retention and fluid status (4) medical conditions affecting athletic performance.

### 1. Injury Predisposition

Injuries are a major problem in athletics. Most injuries are connective tissue injuries. Several studies have confirmed that connective tissue gene variations are associated with a predisposition to injury such as anterior cruciate ligament rupture [10-14]. Physical training and kinesiology studies have proven that focused exercises to the knee joint can reduce the incidence of the ‘at risk’ injury [15]. However, pre-conditioning is hard and takes up valuable time that could be used to optimize other areas of athletic preparation. Genetic testing for a predisposition to injury allows for the coupling of the resultant information to pre-habilitation regimens that are personalized based on the genetics of the athlete.

Sequence variations within several genes have to date to be associated with risk of ACL ruptures and Achilles tendinopathy. Other soft tissue injuries such as shoulder dislocation have also shown to occur at much higher rates within families, indicating a strong genetic component.

a. The COL5A1 Gene

The COL5A1 gene provides instructions for making a component of collagen. Collagens form a family of proteins that strengthen and support many tissues in the body, including skin, ligaments, bones, tendons, muscles, and the space between cells and tissues called the extracellular matrix. The COL5A1 gene produces a component of type V collagen, called the pro-alpha1(V) chain. Three of these chains combine to make a molecule of type V procollagen. Alternatively, two of these chains can also combine with one pro-alpha2(V) chain (produced by the COL5A2 gene) to form type V procollagen. These triple-stranded rope-like procollagen molecules must be processed by enzymes outside the cell. Once these molecules are processed, they arrange themselves into long, thin fibrils that cross-link to one another in the spaces around cells. The cross-links result in the formation of very strong, mature type V collagen fibers. Type V collagen also plays a role in assembling other types of collagen into fibrils within many connective tissues and is essential for the formation of normal type I collagen fibrils. Female athletes with the CC variant of BstU1 RFLP have a 5 times higher chance of ACL rupture than those without this variant (Posthumus et al., 2009) [12].

b. The COL1A1 Gene

The official name of this gene is “collagen, type I, alpha 1.” COL1A1 is the gene's official symbol. The COL1A1 gene provides instructions for making part of a large molecule called type I collagen. Collagens are a family of proteins that strengthen and support many tissues in the body, including cartilage, bone, tendon, skin, and the white part of the eye (the sclera). Type I collagen is the most abundant form of collagen in the human body.

The COL1A1 gene produces a component of type I collagen called the pro-α1(I) chain. Collagens begin as procollagen molecules, which must be processed by enzymes outside the cell to remove extra protein segments from their ends. Each rope-like procollagen molecule is made up of three chains: two pro-α1(I) chains, which are produced from the COL1A1 gene, and one pro-α2(I) chain, which is produced from the COL1A2 gene. After procollagens are processed, the resulting mature collagen molecules arrange themselves into long, thin fibrils. Individual collagen molecules are cross-linked to one another within these fibrils. The formation of cross-links results in very strong type I collagen fibrils, which are found in the spaces around cells.

Changes in the COL1A1 gene have been related to health conditions. Several specific mutations in the COL1A1 gene are responsible for the arthrochalasia type of Ehlers-Danlos syndrome, osteogenesis imperfect, and risk of developing osteoporosis. Interestingly, the TT genotype of COL1A1 sp1 binding site polymorphism is 85% less likely to get an anterior cruciate rupture than with other genotypes—(Collins et. al.) [16]; (Posthumus, M. et al. 2009) [12]; (Bernad, M. et al. 2002) [17].

c. The COL12A1 Gene

Collagen alpha-1(XII) chain is a protein that in humans is encoded by the COL12A1 gene [18]. This gene encodes the alpha chain of type XII collagen, a member of the FACIT (fibril-associated collagens with interrupted triple helices) collagen family. Type XII collagen is a homotrimer found in association with type I collagen, an association that is thought to modify the interactions between collagen I fibrils and the surrounding matrix. Alternatively spliced transcript variants encoding different isoforms have been identified. The AA genotype of COL12A1 Alu1 RFLP is associated with a 2.4 times increased ACL ruptures in females—Posthumus, M. et al. (2009) [13].

d. The Matrix Metalloprotease (MMP)

Proteins of the matrix metalloproteinase (MMP) family are involved in the breakdown of extracellular matrix in normal physiological processes, such as embryonic development, reproduction, and tissue remodeling, as well as in disease processes, such as arthritis and metastasis. Most MMP's are secreted as inactive proproteins which are activated when cleaved by extracellular proteinases. This gene encodes an enzyme which degrades fibronectin, laminin, collagens III, IV, IX, and X, and cartilage proteoglycans. The enzyme is thought to be involved in wound repair, progression of atherosclerosis, and tumor initiation.

Matrix metalloproteinase (WIMP) and tendonitis have been associated. Variants within the MMP3 gene are associated with Achilles tendinopathy (Raleigh, S. M. et al. (2009) [19]. There is a possible interaction with COL5A1 gene. The GG genotype rs679620 correlates with a 2.5 times increase in Achilles tendionopathy. The CC genotype rs 591058 correlates with a 2.3 times increase in Achilles tendinopathy. AA genotype rs 650108 correlates with a 4.9 times increase in Achilles tendinopathy.

e. The COL5A1 Gene

The official name of this gene is “collagen, type V, alpha 1.” The COL5A1 gene provides instructions for making a component of collagen. Collagens form a family of proteins that strengthen and support many tissues in the body, including skin, ligaments, bones, tendons, muscles, and the space between cells and tissues called the extracellular matrix. The COL5A1 gene produces a component of type V collagen, called the pro-alpha1(V) chain. The COL5A1 gene is associated with Ehlers-Danlos syndrome.

f. Tenascin C

Tenascin C (human hexabrachion) is a protein that in humans is encoded by the TNC gene [20]. Tenascin C=a guanine-thymine (GT) dinucleotide repeat (a tandem repeat consisting of a repeated 2-base pair sequence of varying lengths in individuals within intron 17) Tenascin is an extracellular matrix protein implicated in guidance of migrating neurons as well as axons during development, synaptic plasticity as well as neuronal regeneration. It is thought to promote neurite outgrowth from cortical neurons grown on a monolayer of astrocytes. Tenascin C has been shown to interact with fibronectin. The tenascin-C gene is associated with Achilles tendon injury (Mokone, G G et al. (2005) [11]. In this study, 18 different alleles (alternative forms of a specific gene) of the GT dinucleotide repeat polymorphism within the TNC gene were identified within the 2 groups studied. The novel finding of this study was that the allele distributions of the GT dinucleotide repeat polymorphism within the TNC gene were significantly different between the subjects presenting with symptoms of Achilles tendon injuries and the asymptomatic subjects. The frequency of the alleles containing 12 and 14 GT repeats was significantly higher in the symptomatic subjects, whereas the frequency of the alleles containing 13 and 17 GT repeats was significantly higher in the asymptomatic control subjects [11].

g. APOE

Apolipoprotein E (APOE) is a class of apolipoprotein found in the chylomicron and IDLs that binds to a specific receptor on liver cells and peripheral cells. It is essential for the normal catabolism of triglyceride-rich lipoprotein constituents.

APOE is essential for the normal catabolism of triglyceride-rich lipoprotein constituents. [21] APOE was initially recognized for its importance in lipoprotein metabolism and cardiovascular disease. More recently, it has been studied for its role in several biological processes not directly related to lipoprotein transport, including Alzheimer's disease (AD), immunoregulation, and cognition.

In the field of immune regulation, a growing amount of studies point to APOE's interaction with many immunological processes, including suppressing T cell proliferation, macrophage functioning regulation, lipid antigen presentation facilitation (by CD1) to natural killer T cell as well as modulation of inflammation and oxidation [22].

Neonates with brain injuries and/or defects who also have abnormalities in the APOE gene may have an increased risk for cerebral palsy, according to researchers at the Northwestern University Feinberg School of Medicine. Defects in APOE result in familial dysbetalipoproteinemia, or type III hyperlipoproteinemia (HLP III), in which increased plasma cholesterol and triglycerides are the consequence of impaired clearance of chylomicron, VLDL and LDL remnants.

APOE is 299 amino acids long and transports lipoproteins, fat-soluble vitamins, and cholesterol into the lymph system and then into the blood. It is synthesized principally in the liver, but has also been found in other tissues such as the brain, kidneys, and spleen. In the nervous system, non-neuronal cell types, most notably astroglia and microglia, are the primary producers of APOE, while neurons preferentially express the receptors for APOE. There are seven currently identified mammalian receptors for APOE which belong to the evolutionarily conserved low density lipoprotein receptor gene family.

The protein, ApoE, is mapped to chromosome 19 in a cluster with Apolipoprotein C1 and the Apolipoprotein C2. The APOE gene consists of four exons and three introns, totaling 3597 base pairs. In melanocytic cells APOE gene expression may be regulated by MITF [23].

ApoE is polymorphic [24] with three major isoforms, ApoE2, ApoE3, ApoE4, which translate into three alleles of the gene: Normal: ApoE-ε3 and Dysfunctional: ApoE-ε2 and ApoE-ε4.

These allelic forms differ from each other only by amino acid substitutions at positions 112 and 158 [25], The E2 allele has a Cys at positions 112 and 158 in the receptor-binding region of ApoE. The E3 allele is Cys-112 and Arg-158. The ApoE E4 allele is Arg at both positions [26]. These have profound physiological consequences: E2 is associated with the genetic disorder hyperlipoproteinemia type III and with both increased and decreased risk for atherosclerosis. Individuals with an E2/E2 combination may clear dietary fat slowly and be at greater risk for early vascular disease and type III hyperlipoproteinemia—94.4% of such patients are E2/E2, while only ˜2% of E2/E2 develop the disease. So other environmental and genetic factors are likely to be involved [27-29]. E3 is found in approximately 64 percent of the population. It is considered the “neutral” Apo E genotype. E4 has been implicated in atherosclerosis and Alzheimer's disease, impaired cognitive function, and reduced neurite outgrowth. ApoE is a target gene of the liver X receptor, a nuclear receptor member that plays a role in the metabolism regulation of cholesterol, fatty acid, and glucose homeostasis.

In one embodiment testing for APOE (and for research purposes, the APOE promoter) to provide athletes with this information as well as actionable steps to reduce head injuries. There is mounting evidence that deleterious effects of head trauma are more severe in APOE 4 positive athletes [30-33].

An article, entitled “Anterior Cruciate Ligament (ACL) Injury Prevention” is herein incorporated by reference, (2008) Anterior Cruciate Ligament (ACL) Injury Prevention, in American Orthopaedic Society for Sports Medicine (Barry P. Boden, M., Ed.) [15].

### ACL Injury Rates

The anterior cruciate ligament (ACL) is one of the most commonly injured ligaments in the knee. Approximately 150,000 ACL injuries occur in the United States each year. Female athletes participating in basketball and soccer are two to eight times more likely to suffer an ACL injury compared to their male counterparts. Recent data from the Women's National Basketball Association indicates white European-American players may be at increased risk for ACL injury compared with African-American, Hispanic or Asian players.

Athletes who have suffered an ACL injury are at increased risk of developing arthritis later on in life, even if they have surgery for the injury. ACL injuries account for a large health care cost estimated to be over half-billion dollars each year.

Researchers believe there are external and internal factors associated with ACL injury. External factors include any play where the injured athlete's coordination is disrupted just prior to landing or slowing down (deceleration). Examples of a disruption include being bumped by another player, landing in a pothole, or a ball deflection. Other external factors which have been studied include the effect(s) of wearing a brace, shoe-surface interface (how certain types of athletic footwear perform on different surfaces), and the playing surface itself.

Internal factors include differences in the anatomy of men and women, increased hamstring flexibility, increased foot pronation (flat-footed), hormonal effects, and variations in the nerves and muscles which control the position of the knee. Anatomical differences between men and women, such as a wider pelvis and a tendency towards “knock knee” in women, may predispose women to ACL injury. Differences in ACL injury rates between men and women seem to begin shortly after puberty because the nerve/muscle system (coordination) adapts at a slower pace than the anatomical and hormonal changes. It is possible that the incidence of injuries in women increases at this age because the nerve/muscle system (coordination) adapts to these changes at a slower rate than in men. Women also tend to have knees that are less stiff than men, placing more forces on the ligaments. In addition, the female hormone estrogen may relax or allow stretching of the ACL, thereby predisposing female athletes to ACL injury. Nerve/muscle factors pertain to the interaction and control of the knee by the quadriceps and hamstrings muscles in the legs. Researchers are very interested in studying this particular factor since it may be the easiest to modify.

How do ACL Injuries Occur?

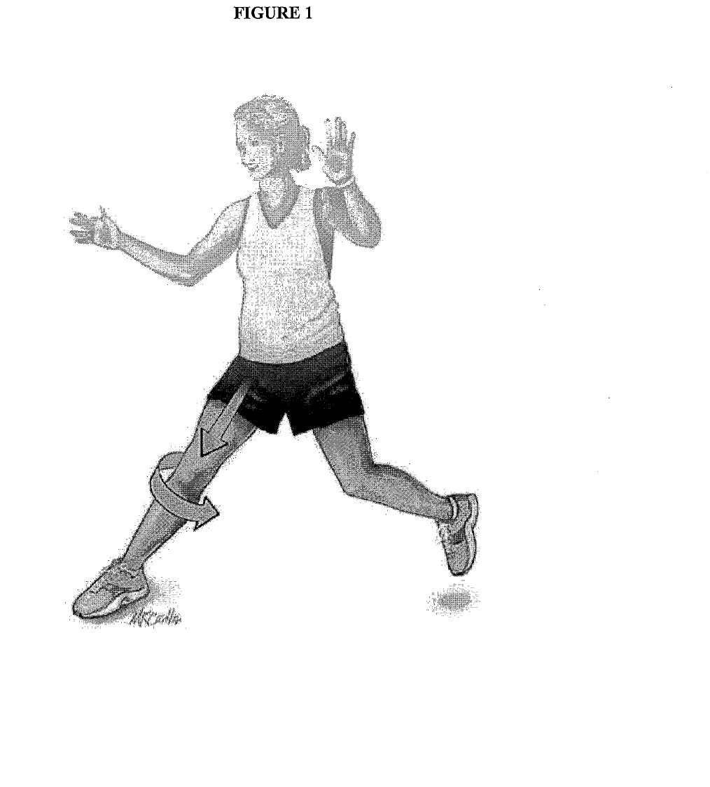

Careful study of videos of athletes tearing an ACL show that approximately 70 percent of these injuries are noncontact and 30 percent occur during contact. The noncontact injuries usually occur during landing or sharp deceleration [34]. In these cases, the knee at the time of injury is almost straight and may be associated with valgus (inward) collapse (see FIG. 1). The athlete often lands with a flat-foot position and the leg is placed in front or to the side of the trunk.

Pre-Habilitation Regimen

In one embodiment, the present invention contemplates utilizing a pre-habilitation regimen in order to prevent injury, including but not limited to ACL injury. In one embodiment, the present invention contemplates a method for conditioning an athlete, said method comprising: a) determining the genotype of said athlete for at least one gene associated with a predisposition to athletic performance; and b) preparing a pre-habilitation regimen, wherein the pre-habilitation regimen is selected based on the determined genotype. In one embodiment, the pre-habilitation regimen comprises plyometrics. In one embodiment, the regimen comprises balancing exercises. In one embodiment, the regimen comprises strengthening exercises (e.g. leg strengthening exercises).

Specific ACL Protocols to Reduce ACL Rupture Rate:

The majority of published studies demonstrate that neuromuscular training has an approximately 50% efficacy rate for decreasing relative ACL injury risk in female athletes in landing and cutting sports like soccer, basketball, volleyball, and team handball. Neuromuscular training alters active knee joint stabilization in the laboratory and aids in decreasing ACL injury rates in female athletes in the field.

Hewett et al. reported the first prospective study of the effects of a neuromuscular training program on ACL injury in the high-risk female sports population [3]. The rate of ACL injury was decreased 45% in the trained group relative to the untrained group. The findings of Hewett et al. [35] have been subsequently confirmed by several studies that used similar neuromuscular training protocols in young female athletes [4, 5]. Considered together, these studies provide strong evidence demonstrating that neuromuscular training is likely to prove an effective solution to the problem of sex bias in ACL injury risk.

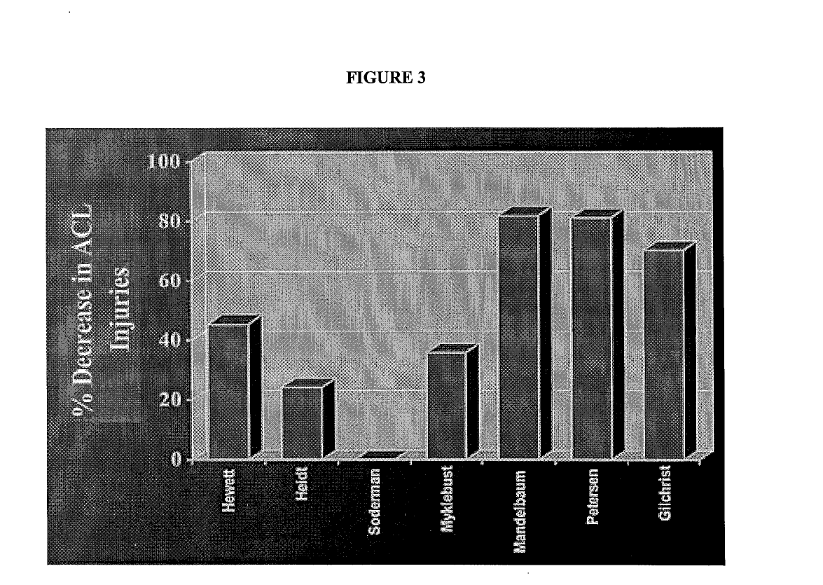

In a prospective study by Hewett et al., trained females were no different than untrained males [3]. Training resulted in great differences in noncontact ACL injuries between the female groups. These results indicate that neuromuscular training decreases injury risk in female athletes. Although the study by Hewett et al. [3] was the first to demonstrate significant decreases with neuromuscular training specifically in the female athlete, other studies have demonstrated similar significant decreases or trends toward significant changes in female, male, and mixed gender populations. FIG. 3 shows the relative percentage decreases in relative injury rates following various training programs.

How does Neuromuscular Training Decrease Incidence of ACL Injury?

Four neuromuscular imbalances are observed more often in female than male athletes. The first observed neuromuscular imbalance is the tendency for females to be ligament dominant. Females demonstrate a tendency to allow stress on ligaments prior to muscular activation to absorb ground reaction forces. Typically during single-leg landing, pivoting, or deceleration, as often occurs during ACL injury, the female athlete allows the ground reaction force to control the direction of motion of the lower extremity joints, especially the knee joint. The lack of dynamic muscular control of the joint leads to increased valgus motion, increased force, and high torque at the knee and ACL.

Another imbalance is termed quadriceps dominance. With quadriceps dominance, female athletes activate their knee extensors preferentially over their knee flexors during sports movements to stabilize their knee joint, which accentuates and perpetuates strength and coordination imbalances between these muscles.

A third imbalance is leg dominance. Leg dominance is the imbalance between muscular strength and coordination on opposite limbs, with 1 limb often demonstrating greater strength and coordination. Limb dominance may place both the weaker, less-coordinated limb and the stronger limb at increased risk of ACL injury. The weaker limb is compromised in its ability to dissipate forces and torques, while the stronger limb may be subject to high forces and torques due to increased dependence and increased loading on that side in high-force situations.

The final imbalance often observed in female athletes is trunk dominance. Trunk dominance is characterized by increased motion of the body's center of mass due to the absence of neuromuscular control of approximately two-thirds of the body mass during single-leg landing, pivoting, or deceleration [36-38].

### Ligament Dominance—High Torques at the Knee and High Impact Forces

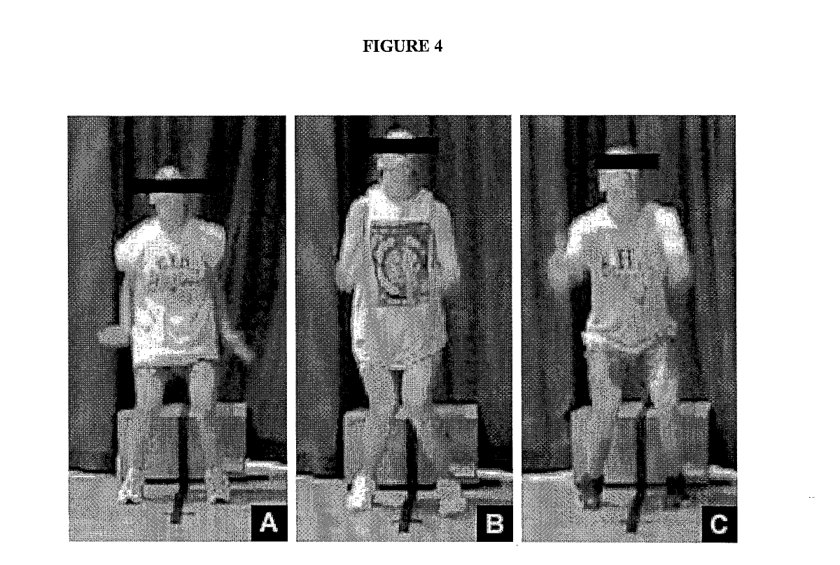

Typically during single-leg landing, pivoting, or deceleration, the motion of the female athlete's knee joint is directed by the ground reaction forces, rather than by the athlete's musculature. This results in high knee valgus motion and high ground reaction forces. FIG. 4 shows the gender disparity in knee abduction motion and load between female and male athletes when dropping off of a box and progressing into a maximum vertical jump.

### Quadriceps Dominance—Decreased Posterior Kinetic Chain Torques

The problem of quadriceps dominance has been documented in the literature [35, 39]. With quadriceps dominance, female athletes tend to activate their knee extensors preferentially over their knee flexors to control knee stability. This over-reliance on the quadriceps muscles leads to imbalances in strength and coordination between the quadriceps and the knee flexor musculature. Quadriceps dominance must be addressed and overcome with dynamic neuromuscular training.

### Leg Dominance—Leg-to-Leg Imbalances in Muscle Recruitment, Strength, and Stability

Female athletes have been reported to generate lower knee flexor torques on the nondominant than in the dominant leg [35]. Side-to-side imbalances in neuromuscular strength, flexibility, and coordination have been shown to be important predictors of increased ACL injury risk [3, 35, 40]. Knapik et al. demonstrated that side-to-side balance in strength and flexibility is important for the prevention of injuries, and when imbalances are present, the athlete is more injury prone [40]. Baumhauer et al. also found that individuals with neuromuscular (muscle strength) imbalances exhibited a higher incidence of injury [41].

### Trunk Dominance—Excessive Motion of the Body's Center of Mass

During landing, pivoting, or deceleration, the motion of the female athlete's trunk is often excessive and directed by that body segment's inertia, rather than by the athlete's core muscle contraction patterns. This results in excessive trunk motion, especially in the frontal or coronal plane, and high ground reaction forces and knee joint abduction torques (knee load).

It is important to note that several knee injury prevention training programs have been published and shown to be effective in improving neuromuscular deficits and reducing the risk of knee injuries, particularly in the female at-risk athlete. All successful programs incorporate the following key elements: a dynamic warm-up period that is high energy and efficient; plyometric/jump training with emphasis placed on body posture and control, trunk positioning, dynamic core balance, and entire-body control through a specific task; strength training for the core and lower extremity; sports-specific aerobic and skill components; and pre-season and in-season training programs that are strictly followed. Pre-season training program may be 6 to 8 weeks in duration, 3 days a week for up to 1.5 hours per day. In-season maintenance programs can be done in 15 minutes during pre-game warm-up 3 times per week [42].

### Individualize Equipment to Reduce ACL Risk, Tendonitis, etc., According to Genotype.

In one embodiment, the invention relates to modifying training exercise equipment for and improved regimen tailored to reduce injury risk associated with a certain genotype. For example, if someone who we tested was a higher risk for ACL, one could deflate their Bosu ball or calibrate their wobble board to provide more wobble—thereby enhancing the neuromuscular stimulus. In another embodiment the invention relates to providing recommendations on how much to adjust prehabilitation training exercise equipment based upon said genotype. For example bosu balls, patellar tendon straps, Achilles tendon straps, etc., cold be adjusted: inflate the ball, or tighten the strap, or whatever, based on our personalized test—with more wobble (more neuromuscular training) or tighter straps for individuals who were more at danger for an ACL or tendonitis. In another embodiment training exercise equipment is selected from the group including: bosu balls, patellar tendon straps, Achilles tendon straps, elastic exercise bands, wobble board, and the like. The invention relates to instructing those who needed enhanced neuromuscular stimulus or tendon support to be aware of this and train differently. In another embodiment, the invention relates to adjusted training program based upon the genotype related to injury susceptibility. In one embodiment, the invention relates to the susceptibility to the following injuries: ACL injury, MCL, tendonitis, shin splints, bone spurs, plantar fasciitis Ankle sprains, Achilles tendonitis, Patellofemoral syndrome (injury resulting from the repetitive movement of your kneecap against your thigh bone), meniscus tears, shoulder dislocation, AC separation (also known as a “separated shoulder”), and concussions. In another embodiment, the invention relates to a prehabilitation program in which the frequency, number (repetitions), and type of training exercises is adjusted based upon the individual's genotype.

The goal of this program is to avoid injury by teaching athletes strategies to avoid vulnerable positions, improve strength and flexibility, and improve proprioception, Proprioception meaning “one's own” and perception, is the sense of the relative position of neighboring parts of the body. Unlike the exteroceptive senses by which we perceive the outside world, and interoceptive senses, by which we perceive the pain and movement of internal organs, proprioception is a third distinct sensory modality that provides feedback solely on the status of the body internally. It is the sense that indicates whether the body is moving with required effort, as well as where the various parts of the body are located in relation to each other. If we are able to prevent just 1 ACL injury, it is worth the effort. With genotype analysis, education, and training we should see a decrease in this dreaded injury, which is often season- and career-ending to some.

### 2. Human Performance and Associated Genes

A wide variety of factors determines athletic success: genetics, epigenetics, training, nutrition, motivation, advances, in equipment and other environmental factor. Genetics has a great influence over components of athletic performance such as strength, power, endurance, muscle fiber size and composition, flexibility, neuromuscular coordination, temperament and other phenotypes. Accordingly, elite athleticism is a heritable trait. Approximately ⅔ of the variance in athlete status is explained by additive genetic factors. The remainder is due to environmental factors. Many studies have identified genes associated with physical performance—the major genes along with a description of this relationship are set forth below.

a. Actn3 (Actinin 3)

The human ACTN3 gene encodes the protein α-actinin-3, a component of the contractile apparatus in fast skeletal muscle fibers. Skeletal muscle is composed of long cylindrical cells called muscle fibers. There are two types of muscle fibers, slow twitch or muscle contraction (type I) and fast twitch (type II). Slow twitch fibers are more efficient in using oxygen to generate energy whilst fast twitch fibers are less efficient. However, fast twitch fibers fire more rapidly and generate more force. These are also called the white muscle fibers and red muscles fibers respectively. On average each person has an even percentage of each fiber type but Olympic sprinters tend to have around 80% fast twitch fibers. Conversely, Olympic marathon runners tend to have around 80% slow twitch. There is controversy whether training may alter the percentage of fiber type percentage over time. Each muscle fiber is composed of long tubes called myofibrils which in turn are composed of filaments. There are two types of filaments: actin (thin filaments) and myosin (thick filaments) which are arranged in parallel. A muscle contraction involves these filaments sliding past each other. Actin filaments are stabilized by actin binding proteins known as actinins of which there are two main types, type 2 and type 3. Each of these is encoded by a specific gene, ACTN2 and ACTN3 respectively. ACTN2 is expressed in all skeletal muscle fibers whereas ACTN3 is expressed only in fast twitch fibers.

A mutation (rs1815739; R577X) has been identified in the ACTN3 gene which results in a deficiency of alpha-actinin 3 in a significant proportion of the population [43]. Based on ethnicity the deficiency is found in 20-50% of people. Generally, Africans have the lowest incidence of the mutation whilst Asians have the highest. Studies have linked the fiber twitch type with ACTN3, i.e. fast twitch fiber abundant individuals carry the non-mutant gene version. C is power allele (The C DNA change causes an R protein change). Also, studies in elite athletes have shown that the ACTN3 gene may influence athletic performance. Whilst the non-mutant version of the gene is associated with sprint performance, the mutant version is associated with endurance [44-47]. T is endurance allele (The T DNA change causes an X protein change) [44]. Therefore, heredity or genetics is currently thought to play the greatest role in the determination of muscle fiber.

b. Angiotensin Converting Enzyme (ACE) Gene Variation

Angiotensin I-converting enzyme (ACE, EC 3.4.15.1), an exopeptidase, is a circulating enzyme that participates in the body's renin-angiotensin system (RAS), which mediates extracellular volume (i.e. that of the blood plasma, lymph, and interstitial fluid), and arterial vasoconstriction. It is secreted by pulmonary and renal endothelial cells and catalyzes the conversion of decapeptide angiotensin I to octapeptide angiotensin II. It has two primary functions: 1) ACE catalyses the conversion of angiotensin I to angiotensin II, a potent vasoconstrictor in a substrate concentration dependent manner. 2) ACE degrades bradykinin, a potent vasodilator, and other vasoactive peptides. These two actions make ACE inhibition a goal in the treatment of conditions such as high blood pressure, heart failure, diabetic nephropathy, and type 2 diabetes mellitus Inhibition of ACE (by ACE inhibitors) results in the decreased formation of angiotensin II and decreased metabolism of bradykinin, leading to systematic dilation of the arteries and veins and a decrease in arterial blood pressure. In addition, inhibiting angiotension II formation diminishes angiotensin II-mediated aldosterone secretion from the adrenal cortex, leading to a decrease in water and sodium reabsorption and a reduction in extracellular volume.

Angiotensin Converting Enzyme (ACE) Gene variation—I allele is a 287 base pair insertion and the D allele is the deleted form of the variant (Myerson, S. et al. (1999) [48]. The presence of the extra fragment is associated with lower circulating and tissue ACE activity, and this variant of the ACE gene is called the I (or insertion) allele. The absence of this fragment (the deletion or D allele) is associated with relatively higher ACE activity.

c. The BDKRB2 Gene

This gene encodes a receptor for bradykinin. The 9 aa bradykinin peptide elicits many responses including vasodilation, edema, smooth muscle spasm and pain fiber stimulation. This receptor associates with G proteins that stimulate a phosphatidylinositol-calcium second messenger system. Alternate start codons result in two isoforms of the protein. BDKRB2-BDKRB2-9 haplotype significantly associated with endurance among elite athletes (Williams, A. G et al. (2004) [49]. This study suggests B₂R −9 (rather than +9) allele is associated with higher skeletal muscle metabolic efficiency and also with endurance athletic performance. Moreover, these associations were greatest among individuals with highest kinin receptor activity as marked by the ACE I (high kinin ligand generation) allele and B₂R-9 (high receptor expression) allele. Such data support recent linkage analyses, which suggest an effect of a locus near to the B₂R gene on performance-related phenotypes, such as cardiac output and stroke volume.

d. The NOS3 Gene

NOS3—nitric acid synthase gene. Nitric oxide is a reactive free radical which acts as a biologic mediator in several processes, including neurotransmission and antimicrobial and antitumoral activities. Nitric oxide is synthesized from L-arginine by nitric oxide synthases ecoded by the NOS3 gene. Variations in this gene are associated with susceptibility to coronary spasm. Multiple transcript variants encoding different isoforms have been found for this gene. NOS3 interacts with Bradykinin receptor gene (Saunders, C. J. et al. 2006) [50].

e. The ADRB2 Gene

The ADRB2 gene encodes beta-2-adrenergic receptor which is a member of the G protein-coupled receptor superfamily. This receptor is directly associated with one of its ultimate effectors, the class C L-type calcium channel Ca(V)1.2. This receptor-channel complex also contains a G protein, an adenylyl cyclase, cAMP-dependent kinase, and the counterbalancing phosphatase, PP2A. The assembly of the signaling complex provides a mechanism that ensures specific and rapid signaling by this G protein-coupled receptor. This gene is intronless. Different polymorphic forms, point mutations, and/or down regulation of this gene are associated with nocturnal asthma, obesity and type 2 diabetes. In one gene variant: Arg in the 16 position of the ADRB2 gene (Arg16/Gly single nucleotide polymorphism (SNP) of the ADRB2) correlates with endurance in athletes when compared to another gene variant called ‘Gly’. A study found suggestive evidence that the Arg16Gly polymorphism in the gene encoding for the 132-adrenergic receptor may associate with endurance performance status in white men (Wolfarth, B. et al. 2007) [51]. A second gene variant 2 in location 164 is either ‘Ile’ or ‘Thr’.

f. The AGT Gene

The protein encoded by this gene, pre-angiotensinogen or angiotensinogen precursor, is expressed in the liver and is cleaved by the enzyme refill in response to lowered blood pressure. The resulting product, angiotensin I, is then cleaved by angiotensin converting enzyme (ACE) to generate the physiologically active enzyme angiotensin II. The protein is involved in maintaining blood pressure and in the pathogenesis of essential hypertension and preeclampsia. Angiotensin-2 acts directly on vascular smooth muscle as a potent vasoconstrictor, affects cardiac contractility and heart rate through its action on the sympathetic nervous system, and alters renal sodium and water absorption through its ability to stimulate the zona glomerulosa cells of the adrenal cortex to synthesize and secrete aldosterone Mutations in this gene are associated with susceptibility to essential hypertension, and can cause renal tubular dysgenesis, a severe disorder of renal tubular development. Defects in this gene have also been associated with non-familial structural atrial fibrillation, risk of bipolar affective disorder [52], methamphetamine dependence [53], and inflammatory bowel disease. AGT—angiotensinogen gene variants have been implicated in human performance. There are been links between the M235T gene polymorphism and blood pressure [54], mitral valve prolapse syndrome. T1198C polymorphism of the angiotensinogen gene and antihypertensive response to angiotensin-converting enzyme inhibitors have been linked [55]. The M235T and A(−6)G gene polymorphisms have been linked with coronary heart disease with independence of essential hypertension [56].

g. The AMPD1 Gene

AMPD1 codes for adenosine monophosphate deaminase 1. AMP deaminase plays a critical role in energy metabolism. Adenosine monophosphate deaminase 1 catalyzes the deamination of AMP to IMP in skeletal muscle and plays an important role in the purine nucleotide cycle. Two other genes have been identified, AMPD2 and AMPD3, for the liver- and erythocyte-specific isoforms, respectively. Deficiency of the muscle-specific enzyme is apparently a common cause of exercise-induced myopathy and probably the most common cause of metabolic myopathy in the human [57]. Alternatively spliced transcript variants encoding different isoforms have been identified in this gene [58]. The AMPD1 C34T mutation implicated in endurance (Rubio, L. et al. 2005) [59].

h. Mitochondrial DNA

Mitochondrial DNA—There are 37 mitochondrial genes and alleles at several sites define 9 different haplotypes. One haplotype called T occurs infrequently in elite athletes indicating these athletes are at a genetic disadvantage for performance in endurance events. Haplogroup T has been associated with coronary artery disease and diabetic retinopathy [60]. Two other haplotypes—J and K are also less frequent in endurance athletes (Castro, M. G. et al. 2007) [61]. Mitochondrial DNA haplogroups and risk of transient ischemic attack and ischemic stroke has also been associated [62].

i. pparGC1a

The pparGC1a gene stands for peroxisome proliferator-activated receptor gamma, coactivator 1 alpha [63]. The protein encoded by this gene is a transcriptional coactivator that regulates the genes involved in energy metabolism. This protein interacts with PPARgamma, which permits the interaction of this protein with multiple transcription factors. This protein can interact with, and regulate the activities of, cAMP response element binding protein (CREB) and nuclear respiratory factors (NRFs). It provides a direct link between external physiological stimuli and the regulation of mitochondrial biogenesis, and is a major factor that regulates muscle fiber type determination. This protein may be also involved in controlling blood pressure, regulating cellular cholesterol homoeostasis, and the development of obesity [64]. The Gly482Ser variant predicts exceptional endurance in runners (He, et al. 2008) [65].

j. NRF-1

This gene encodes a protein that homodimerizes and functions as a transcription factor which activates the expression of some key metabolic genes regulating cellular growth and nuclear genes required for respiration, heme biosynthesis, and mitochondrial DNA transcription and replication. The protein has also been associated with the regulation of neurite outgrowth. The protein is a transcription factor that activates the expression of the EIF2S1 (EIF2-α) gene. It links the transcriptional modulation of key metabolic genes to cellular growth and development. It has been linked to the aforementioned pparGC1a [66]. Alternate transcriptional splice variants, which encode the same protein, have been characterized. Additional variants encoding different protein isoforms have been described but they have not been fully characterized. He, et al. found an association between two NRF-1 polymorphisms (rs2402970 and rs6949152) and human aerobic capacity (and its trainability) expressed as ventilatory threshold (VT) or running economy (RE) [67].

k. NRF-2

NRF-2 stands for nuclear respiratory factor 2 and is a known activator of transcription. Nuclear respiratory factor 2 is comprised of five subunits (α, β, δ1, δ2) which are encoded by two genes, the a gene which is located on 21q21.3, and the b gene that is located on 15q21.2.

Genomic DNA was extracted from white cells of peripheral blood and the genotypes were examined in SNPrs12594956, rs8031031 and rs7181866 by PCR-RFLP. Genotype distributions were in Hardy-Weinberg equilibrium at three loci, and linkage disequilibrium was observed (LD D′=1 and r2=0.903) between rs8031031 and rs7181866. The VO₂ max was associated with rs12594956 at baseline while the training response of VO₂ at RE, was associated with rs12594956, rs8031031 and rs7181866. When the three SNPs were considered together, those carrying the ATG haplotype had 57.5% higher training response in VO₂ at RE (p=0.006) than non-carriers. In conclusion, polymorphisms in NRF2 gene may explain some of the between person variance in endurance capacity (He et al. 2007) [68].

### 3. Salt Retention, Fluid Management and Drug Metabolism

Certain populations are particularly at risk for developing various fluid and electrolyte disorders-among them, hypernatremia (elevated blood sodium levels), hyponatremia (depleted blood sodium levels), volume depletion, and edema. These concerns are of particular interest to professional, non-professional athletes, and military personnel (for whom dehydration of as little as 2 percent (dehydration of between 5 and 10 percent is common) can reduce athletic performance by as much as 20 percent). Dehydration can lead to a number of serious medical complications, including renal failure, heart failure, brain damage, heat stroke, and death. If not treated in a timely fashion, mortality rates may exceed 50 percent [69]. Correcting fluid and electrolyte disorders is extraordinarily difficult. Because electrolyte balance and hydration requirements are unknown, individuals are left to formulate their own “best-guess” estimates of fluid and electrolyte replacement needs. These best-guess estimates are rarely accurate, as the deaths of Orioles pitcher Steve Bechler (2003), Minnesota Vikings offensive tackle Korey Stringer (2001), marathoners Rachel Townsend (2003), Cynthia Lucero (2002), and Kelly Barrett (1998), and a number of military trainees, among many others, bear testimony to. The ability to perform at an elite level in inexorably tied to maintaining a proper hydration and electrolyte balance.

Dehydration, or risk thereof, is extraordinarily difficult to monitor. First, severe dehydration can occur very rapidly, in just a couple of hours. Second, many of the symptoms associated with dehydration (e.g. fatigue, confusion, dry mouth) do not appear until substantial fluids have been lost and medical complications take hold. Finally, many of the symptoms of dehydration may be present in normally-hydrated, at-risk individuals (among athletes, anaerobic exercise often causes dry mouth and/or fatigue). The implication of the latter is that individuals at risk for dehydration, or their health care providers, often attribute classic signs of dehydration to other conditions and do not seek to correct the condition as a result. An enhanced understanding of the nature of various fluid and electrolyte disorders and the genetic predisposition towards them would enable an athlete to better prepare for his or her hydration and electrolyte balance needs and maintenance ensuring elite performance.

There is a high degree of genetic variability in genes regulating salt retention, volume status and drug metabolism. An athlete's health (reducing the chance for hypertension) and performance (optimizing the dynamic plasma concentrations of electrolytes) can be improved by assessing the genetic basis of an athlete's salt retention machinery and developing a personalized fluid management strategy. The CYP3A genetic variation is tied to salt status and hypertension which can have significant implications for athletes. CYP 450 genotyping provides current basis for cancer and indications of chronic drug administration such as depression. Two candidate genes play important roles in salt retention.

a. CYP3A5 Gene

CYP3A isoenzymes are the predominant subfamily of CYP enzymes, making it one of the most important drug-metabolizing enzymes. The genes for CYP3A isoenzymes are expressed primarily in the liver and small intestines [70, 71]. Hepatic CYP3A4 isoenzyme has been estimated to metabolize almost 50% of currently used drugs as well as endogenous and exogenous corticosteroids. Intestinal CYP3A4 isoenzyme contributes significantly to the first-pass metabolism of orally administered drugs [72]. There is large interindividual variability in genetic expression for, CYP3A exceeding 30-fold in some populations [73], but evidence for polymorphic activity has been elusive until recently. Consequently, these variations play a significant role in the variability of oral bioavailability and metabolism of CYP3A substrates, including HIV protease inhibitors, benzodiazepines, calcium channel blockers, hydroxymethylglutaryl coenzyme A-reductase inhibitors, antineoplastic drugs, nonsedating antihistamines, and immunosuppressants. These variations can result in differences in drug efficacy and toxicity among individuals.

The CYP3A5 gene is part of a family known as cytochrome P450 genes, which help the body to break down and eliminate a wide range of compounds, including many drugs and salt. In the kidney, CYP3A5 acts to retain salt. One version of this gene, however, contains a mutation known as CYP3A5*3, which produces a truncated, non-functional salt-retention protein. A recent study (Thompson et al.) [74] analyzed variations of the salt conservation gene in 1,064 individuals drawn from 52 worldwide populations. The mutation was least common (meaning the salt retention gene was in its active form) in sub-Saharan Africa, ranging from a low of only 6 percent of Nigerians (Latitude 8° N) to 31 percent among the Senegalese (12° N). Rates of the nonfunctional gene were higher among populations in East Asia, ranging from 55 percent among the Dai of China (21° N) to 75 percent among Han Chinese (32° N) to 77 percent among Japanese (38° N) and 95 percent among the Uygur of China (44° N). Rates in Europe were uniformly high, ranging from 80 to 95 percent in Italy, France and Russia. The highest rate, 96 percent, was found among the Basque, an isolated ethnic group of uncertain origins now concentrated in the Pyrenees Mountains (43° N).

The above-referenced study has major yet unrecognized implications for athletes. For example, a recent study in the Journal of the American Medical Association analyzed the prevalence of cardiovascular risk factors among current National Football League players [75]. This study of 504 active veteran football players found that, when compared to age matched controls of the general population, these athletes had lower levels of impaired fasting glucose document but a much higher rate of hypertension. 13.8% of active NFL players are hypertensive compared to 5.5% of age-matched controls.

NFL players lose a great deal of fluid on a daily basis and regularly drink nutritional supplements containing sodium and potassium. Often times the methodology of choice of these supplements is based on color and taste. With a documented prevalence of hypertension, and in light of the high degree of variability of genes overseeing salt retention, athletes could easily be tested to determine their unique salt sensitivity profile. This could be done with an eye towards developing an individualized fluid and salt strategy for the athlete. Further testing could be conducted to determine if levels of hypertension can be lowered, and if other elements of performance can be enhanced by optimizing fluids delivered to the athlete. Existing whole-genome scanning technology can be adapted to conduct genetic analysis of athletes to identify known and novel gene variants governing salt retention. The intersection between genetics and human physiology represent a new and powerful frontier for understanding and optimizing human athletic performance.

### 4. Athletes Taking Medications and Medical Conditions

Athletes operate within physical requirements that demand high levels of performance. Small decrements in performance can lead to negative outcomes for individual and/or team. Athletes often take medications on a chronic basis. Representative drugs include anti-inflammatory medications, muscle relaxants, and antibiotics. Regarding medicines, athletes have unique medical needs, making correct dosing important. Methicillin resistant Staphylococcus aureus, asthma, anti-inflammatory medications, Attention-deficit hyperactivity disorder (ADHD), and other neurological indications mean that more athletes than ever are taking chronic medications.

Because of the high stakes involved, athletes have an extremely high need for optimal dosing. Doses which are too low do not help the underlying medical problem, and doses that are too high can cause side effects. Therefore doses that are either too high or too low can negatively impact athletic performance.

Methicillin-resistant staphylococcus aureus (MRSA) is quickly developing into a widespread threat to athletes in all sports as well as the general population. MRSA is a very serious infection that was once confined mostly to hospitals. The infection has recently crossed over to the general population, and is now infecting athletes of all sports and levels [76].

In particular, methacillin resistant staphylococcus infections are a major problem for elite athletic programs. Athletes typically train in close proximity. Athletes frequently train on turf and other surfaces which are exposed to bodily fluids such as blood, sweat and sputum, which can contain staphylococcus. Athletes receive turf burns which often go unreported to the team trainer until the pain of an infection causes the athlete to report the incidence. This environment can facilitate outbreaks of methacillin resistant staphylococcus infection which, if treatment fails, requires intravenous antibiotics or debridement, in each case negatively impacting the athlete's ability to participate.

In November 2008, former Browns receiver Joe Jurevicius sued the Cleveland Browns, the Cleveland Clinic and two team physicians over a staph infection that most likely has ended his NFL career [77]. Jurevicius, 34, is the first of six known Browns players diagnosed with staph infections since 2003 to file a lawsuit [77]. One of those, former Browns tight end Kellen Winslow, contracted staph twice, once in 2005 and again in 2008 [78]. Another, Cleveland native and St. Ignatius product LeCharles Bentley, had to leave football after suffering his potentially limb- and life-threatening infection in 2006.

Research to date has shown that genetically assessing p450 status can lead to enhanced treatment by incorporating the precise rate of drug metabolism governed by specific gene variants of Cyp genes of patients [79, 80].

In one embodiment, the invention would provide for Cyp testing of athletes, with the information provided to team personnel to use in developing dosing strategies for antibiotics and other medications to be administered to the athlete on a chronic basis.

### REFERENCES

1. Pearson, T. A. and Manolio, T. A. (2008) How to Interpret a Genome-wide Association Study, JAMA 299, 1335-1344.
2. Assael, S. (2009) Cheating is so 1999: Which is why The Magazine spent a year searching for the athletic holy grail: a sports gene, ESPN: The Magazine Oct. 8, 2009, 88-97.
3. Hewett, T. E. et al. (1999) The effect of neuromuscular training on the incidence of knee injury in female athletes: A prospective study, Am. J. Sports Med. 27, 699-706.
4. Heidt, R. S. et al. (2000) Avoidance of Soccer Injuries with Preseason Conditioning, The American Journal of Sports Medicine 28, 659-662.
5. Mandelbaum, B. (2002) ACL prevention strategies in the female athlete and soccer: implementation of a neuromuscular training program to determine its efficacy on the incidence of ACL injury, in AAOSM 2002 Specialty Day, Dallas, Tex.
6. &Merman, K. et al. (2000) Balance board training: prevention of traumatic injuries of the lower extremities in female soccer players?, Knee Surgery, Sports Traumatology, Arthroscopy 8, 356-363.
7. Myklebust, G et al. (2003) Prevention of anterior cruciate ligament injuries in female team handball players: a prospective intervention study over three seasons, Clin. J. Sport Med. 13, 71-78.
8. Petersen, W. et al. (2005) A controlled prospective case control study of a prevention training program in female team handball players: the German experience, Arch. Orthop. Trauma Surg. 125, 614-621.
9. Gilchrist, J. et al. (2008) A Randomized Controlled Trial to Prevent Noncontact Anterior Cruciate Ligament Injury in Female Collegiate Soccer Players, The American Journal of Sports Medicine 36, 1476-1483.
10. September, A. V., Schwellnus, M. P., and Collins, M. (2007) Tendon and ligament injuries: the genetic component, British Journal of Sports Medicine 41, 241-246.
11. Mokone, G. G. et al. (2005) The Guanine-Thymine Dinucleotide Repeat Polymorphism Within the Tenascin-C Gene Is Associated With Achilles Tendon Injuries, The American Journal of Sports Medicine 33, 1016-1021.
12. Posthumus, M. et al. (2009) The COL5A1 Gene Is Associated With Increased Risk of Anterior Cruciate Ligament Ruptures in Female Participants, The American Journal of Sports Medicine 37, 2234-2240.
13. Posthumus, M. et al. (2009) The association between the COL12A1 gene and anterior cruciate ligament ruptures, British Journal of Sports Medicine, online May 13, 2009.
14. Collins, M. and Raleigh, S. M. (2009) Genetic Risk Factors for Musculoskeletal Soft Tissue Injuries, Med. Sport Sci. 54, 136-149.
15. (2008) Anterior Cruciate Ligament (ACL) Injury Prevention, in American Orthopaedic Society for Sports Medicine (Barry P. Boden, M., Ed.).
16. Collins, M., Posthumus, M., and Schwellnus, M. P. (2009) The COL1A1 gene and acute soft tissue ruptures, British Journal of Sports Medicine, Published Online Feb. 4, 2009.
17. Bernad, M. et al. (2002) Polymorphism in the type I collagen COLIA1 gene and risk of fractures in postmenopausal women, Bone 30, 223-228.
18. Gerecke, D. R. et al. (1997) Complete Primary Structure of Two Splice Variants of Collagen XII, and Assignment of α1(XII) Collagen (COL12A1), α1(IX) Collagen (COL9A1), and α1(XIX) Collagen (COL19A1) to Human Chromosome 6q12-q13, Genomics 41, 236-242.
19. Raleigh, S. M. et al. (2009) Variants within the MMP3 gene are associated with Achilles tendinopathy: possible interaction with the COL5A1 gene, British Journal of Sports Medicine 43, 514-520.
20. Nies, D. E. et al. (1991) The complete cDNA sequence of human hexabrachion (Tenascin). A multidomain protein containing unique epidermal growth factor repeats, J. Biol. Chem. 266, 2818-2823.
21. Singh, P. P., Singh, M., and Mastana, S. S. (2002) Genetic Variation of Apolipoproteins in North Indians, Hum. Biol. 74, 673-682.
22. Zhang, H.-l., Wu, J., and Zhu, J. (2010) The Role of Apolipoprotein. E in Guillain-Barré Syndrome and Experimental Autoimmune Neuritis, Journal of Biomedicine and Biotechnology 2010, 1-12.
23. Hoek, K. S. et al. (2008) Novel MITF targets identified using a two-step DNA microarray strategy, Pigment Cell & Melanoma Research 21, 665-676.
24. Singh, P. P., Singh, M., and Mastana, S. S. (2006) APOE distribution in world populations with new data from India and the UK, Ann. Hum. Biol. 33, 279-308.
25. Lingjun, Z. et al. (2006) Variation at APOE and STH loci and Alzheimer's disease, Behavioral & Brain Functions 2, 1-10.
26. Ghebranious, N. et al. (2005) Detection of ApoE E2, E3 and E4 alleles using MALDI-TOF mass spectrometry and the homogeneous mass-extend technology, Nucleic Acids Res. 33, e149.
27. Breslow, J. L. et al. (1982) Studies of familial type III hyperlipoproteinemia using as a genetic marker the apoE phenotype E2/2, J. Lipid Res. 23, 1224-1235.
28. Feussner, G et al. (1998) Molecular Basis of Type III Hyperlipoproteinemia in Germany, Hum. Mutat. 11, 417-423.
29. Civeira, F. et al. (1996) Apo E variants in patients with type III hyperlipoproteinemia, Atherosclerosis 127, 273-282.
30. McKee, A. C. M. D. et al. (2009) Chronic Traumatic Encephalopathy in Athletes: Progressive Tauopathy After Repetitive Head Injury, J. Neuropathol. Exp. Neurol. 68, 709-735.
31. Ariza, M. et al. (2006) Influence of APOE polymorphism on cognitive and behavioural outcome in moderate and severe traumatic brain injury, Journal of Neurology, Neurosurgery & Psychiatry 77:, 1191-1193.
32. Chiang, M. F., Chang, J. G, and Hu, C. J. (2003) Association between apolipoprotein E genotype and outcome of traumatic brain injury, Acta Neurochir 145, 649-654.
33. Friedman, G. M. et al. (1999) Apolipoprotein E-[epsilon]4 genotype predicts a poor outcome in survivors of traumatic brain injury, Neurology 52, 244-248.
34. Boden, B. P. et al. (2000) Mechanisms of anterior cruciate ligament injury, Orthopedics 23, 573-578.
35. Hewett, T. E. et al. (1996) Plyometric training in female athletes: Decreased impact forces and increased hamstring torques, The American Journal of Sports Medicine 24, 765-773.
36. Hewett, T. E., Torg, J. S., and Boden, B. P. (2009) Video analysis of trunk and knee motion during non-contact anterior cruciate ligament injury in female athletes: lateral trunk and knee abduction motion are combined components of the injury mechanism, British Journal of Sports Medicine 43, 417-422.
37. Hewett, T. F. (2009) Prevention of Noncontact ACL Injuries in Women: Use of the Core of Evidence to Clip the Wings of a “Black Swan”, Current Sports Medicine Reports 8, 219-221.
38. Zazulak, B. T. et al. (2007) Deficits in Neuromuscular Control of the Trunk Predict Knee Injury Risk, The American Journal of Sports Medicine 35, 1123-1130.
39. Huston, L. J. and Wojtys, E. M. (1996) Neuromuscular Performance Characteristics in Elite Female Athletes, Am. J. Sports Med. 24, 427-436.
40. Knapik, J. J. et al. (1991) Preseason strength and flexibility imbalances associated with athletic injuries in female collegiate athletes, Am. J. Sports Med. 19, 76-81.
41. Baumhauer, J. F. et al. (1995) A Prospective Study of Ankle Injury Risk Factors, Am. J. Sports Med. 23, 564-570.
42. Wedderkopp, N. et al. (1999) Prevention of injuries in young female players in European team handball. A prospective intervention study, Scand. J. Med. Sci. Sports 9, 41-47.
43. North, K. N. et al. (1999) A common nonsense mutation results in alpha-actinin-3 deficiency in the general population, Nat. Genet. 21, 353-354.
44. Yang, N. et al. (2003) ACTN3 Genotype Is Associated with Human Elite Athletic Performance, The American Journal of Human Genetics 73, 627-631.
45. Niemi, A.-K. and Majamaa, K. (2005) Mitochondrial DNA and ACTN3 genotypes in Finnish elite endurance and sprint athletes, Eur. J. Hum. Genet. 13, 965-969.
46. Moran, C. N. et al. (2007) Association analysis of the ACTN3 R577X polymorphism and complex quantitative body composition and performance phenotypes in adolescent Greeks, Eur. J. Hum. Genet. 15, 88-93.
47. Roth, S. M. et al. (2008) The ACTN3 R577X nonsense allele is under-represented in elite-level strength athletes, Eur. J. Hum. Genet. 16, 391-394.
48. Myerson, S. et al. (1999) Human angiotensin I-converting enzyme gene and endurance performance, J. Appl. Physiol. 87, 1313-1316.
49. Williams, A. G et al. (2004) Bradykinin receptor gene variant and human physical performance, J. Appl. Physiol. 96, 938-942.
50. Saunders, C. J. et al. (2006) The bradykinin β₂ receptor BDKRB2 and endothelial nitric oxide synthase 3 NOS3 genes and endurance performance during Ironman Triathlons, Hum. Mol. Genet. 15, 979-987.
51. Wolfarth, B. et al. (2007) Association between a β₂-adrenergic receptor polymorphism and elite endurance performance, Metabolism 56, 1649-1651.
52. Meira-Lima, I. V. et al. (2000) Angiotensinogen and angiotensin converting enzyme gene polymorphisms and the risk of bipolar affective disorder in humans, Neurosci. Lett. 293, 103-106.
53. Serý, O., Vojtová, V., and Zvolský, P. (2001) The association study of DRD2, ACE and AGT gene polymorphisms and metamphetamine dependence, Physiol. Res. 51, 43-50.
54. Ortlepp, J. R. et al. (2003) Relation between the angiotensinogen (AGT) M235T gene polymorphism and blood pressure in a large, homogeneous study population, Journal of Human Hypertension 17, 555.
55. Yu, H. et al. (2005) T1198C Polymorphism of the Angiotensinogen Gene and Antihypertensive Response to Angiotensin-Converting Enzyme Inhibitors, Hypertension Research 28, 981-986.
56. Rodriguez-Perez, J. C. et al. (2001) Association of angiotensinogen m235t and a(−6)g gene polymorphisms with coronary heart disease with independence of essential hypertension: the procagene study, J. Am. Coll. Cardiol. 37, 1536-1542.
57. Fishbein, W. N., Vernon, W. A., and Griffin, J. L. (1978) Myoadenylate Deaminase Deficiency: A New Disease of Muscle, Science 200, 545-548.
58. Mahnke-Zizelman, D. K. and Sabina, R. L. (1992) Cloning of human AMP deaminase isoform E cDNAs. Evidence for a third AMPD gene exhibiting alternatively spliced 5′-exons, J. Biol. Chem. 267, 20866-20877.
59. Rubio, J. C. et al. (2005) Frequency of the C34T mutation of the AMPD1 gene in world-class endurance athletes: does this mutation impair performance?, J. Appl. Physiol. 98, 2108-2112.
60. Kofler, B. et al. (2009) Mitochondrial DNA haplogroup T is associated with coronary artery disease and diabetic retinopathy: a case control study, BMC Med. Genet. 10, 35.
61. Castro, M. G et al. (2007) Mitochondrial haplogroup T is negatively associated with the status of elite endurance athlete, Mitochondrion 7, 354-357.
62. Chinnery, P. F. et al. (2010) Mitochondrial DNA haplogroups and risk of transient ischaemic attack and ischaemic stroke: a genetic association study, The Lancet Neurology 9, 498-503.
63. Esterbauer, H. et al. (1999) Human Peroxisome Proliferator Activated Receptor Gamma Coactivator 1 (PPARGC1) Gene: cDNA Sequence, Genomic Organization, Chromosomal Localization, and Tissue Expression, Genomics 62, 98-102.
64. Liang, H. and Ward, W. F. (2006) PGC-1α: a key regulator of energy metabolism, Advances in Physiology Education 30, 145-151.
65. He, Z. et al. (2008) Is there an association between PPARGC1A genotypes and endurance capacity in Chinese men?, Scand. J. Med. Sci. Sports 18, 195-204.
66. Wu, Z. et al. (1999) Mechanisms Controlling Mitochondrial Biogenesis and Respiration through the Thermogenic Coactivator PGC-1, Cell 98, 115-124.
67. He, Z. et al. (2008) NRF-1 genotypes and endurance exercise capacity in young Chinese men, British Journal of Sports Medicine 42, 361-366.
68. He, Z. et al. (2007) NRF2 Genotype Improves Endurance Capacity in Response to Training, Int. J. Sports Med. 28, 717-721.
69. Robbins, D. J. and Hwang, C. G “Systems and methods for measuring sodium concentration in saliva,” United States Patent Application 20060121548 (published Jun. 8, 2006).
70. Cholerton, S., Daly, A. K., and Idle, J. R. (1992) The role of individual human cytochrpmes P450 in drug metabolism and clinical response, Trends Pharmacol. Sci. 13, 434-439.
71. Shimada, T. et al. (1994) Interindividual variations in human liver cytochrome P-450 enzymes involved in the oxidation of drugs, carcinogens and toxic chemicals: studies with liver microsomes of 30 Japanese and 30 Caucasians, J. Pharmacol. Exp. Ther. 270, 414-423.
72. Paine, M. F. et al. (1996) First-pass metabolism of midazolam by the human intestine, Clin. Pharmacol. Ther 60, 14-24.
73. Watkins, P. B. (1995) Cyclosporine and liver transplantation: Will the midazolam test make blood level monitoring obsolete?, Hepatology 22, 994-996.
74. Thompson, E. E. et al. (2004) CYP3A Variation and the Evolution of Salt-Sensitivity Variants, The American Journal of Human Genetics 75, 1059-1069.
75. Tucker, A. M. et al. (2009) Prevalence of Cardiovascular Disease Risk Factors Among National Football League Players, JAMA 301, 2111-2119.
76. Bentz, B. The Newest Threat to Athletes: Methicillin-Resistant Staphylococcus Aureus (MRSA), Buzzle.com, http://www.buzzle.com/editorials/7-12-2006-102152.asp Jul. 1, 2010
77. Campbell, D. (2009) Former Cleveland Browns receiver Joe Jurevicius sues team, doctors, Cleveland Clinic over staph infection, Jun. 26, 2009, The Cleveland Plain Dealer, http://www.cleveland.com/browns/index.ssf/2009/06/joshua_gunter_the_plain_dealer.html Accessed Jul. 1, 2010
78. Starkey, M. (2008) Browns confirm Kellen Winslow's staph infection, Oct. 20, 2008, Cleveland.com, http://www.cleveland.com/browns/index.ssf/2008/10/browns_confirm_winslows_staph.html Sep. 1, 2010
79. Matchar, D. B. et al. (2007) Testing for Cytochrome P450 Polymorphisms in Adults With Non-Psychotic Depression Treated With Selective Serotonin Reuptake Inhibitors (SSRIs) Evidence Report/Technology Assessment No. 146. (Prepared by the Duke Evidence-based Practice Center under Contract No. 290-02-0025.), (Services, U.S. D. o. H. a. H., Ed.), Agency for Healthcare Research and Quality, Rockville, Md.
80. Musana, A. K. and Wilke, R. A. (2005) Gene-Based Drug Prescribing: Clinical Implications of the Cytochrome P450 Genes, Wisconsin Medical Journal 104, 61-66.

TABLE 1
LIST OF GENES CAUSING LONG QT SYNDROME

| Type | OMIM | Mutation | Notes |
|---|---|---|---|
| LQT1 | 192500 | alpha subunit of the | The current through the heteromeric channel (KvLQT1 + |
| | | slow delayed rectifier | minK) is known as I_{Ks}. These mutations often cause LQT |
| | | potassium channel | by reducing the amount of repolarizing current. This |
| | | (KvLQT1 or KCNQ1) | repolarizing current is required to terminate the action |
| | | | potential, leading to an increase in the action potential |
| | | | duration (APD). These mutations tend to be the most |
| | | | common yet least severe. |
| LQT2 | 152427 | alpha subunit of the | Current through this channel is known as I_{Kr}. This |
| | | rapid delayed rectifier | phenotype is also probably caused by a reduction in |
| | | potassium channel | repolarizing current. |
| | | (HERG + MiRP1) | |
| LQT3 | 603830 | alpha subunit of the | Current through this channel is commonly referred to as |
| | | sodium channel (SCN5A) | I_{Na}. Depolarizing current through the channel late in the |
| | | | action potential is thought to prolong APD. The late |
| | | | current is due to the failure of the channel to remain |
| | | | inactivated. Consequently, it can enter a bursting mode, |
| | | | during which significant current enters abruptly when it |
| | | | should not. These mutations are more lethal but less |
| | | | common. |
| LQT4 | 600919 | anchor protein | LQT4 is very rare. Ankyrin B anchors the ion channels in |
| | | Ankyrin B | the cell. |
| LQT5 | 176261 | beta subunit MinK (or | — |
| | | KCNE1) which | |
| | | coassembles with | |
| | | KvLQT1 | |
| LQT6 | 603796 | beta subunit MiRP1 | — |
| | | (or KCNE2) which | |
| | | coassembles with HERG | |
| LQT7 | 170390 | potassium channel | The current through this channel and KCNJ12 (Kᵢᵣ2.2) is |
| | | KCNJ2 (or Kᵢᵣ2.1) | called I_{K1}. LQT7 leads to Andersen-Tawil syndrome. |
| LQT8 | 601005 | alpha subunit of the | Leads to Timothy's syndrome. |
| | | calcium channel | |
| | | Cav1.2 encoded by | |
| | | the gene CACNA1c. | |
| LQT9 | 611818 | Caveolin 3 | |
| LQT10 | 611819 | SCN4B | |
| LQT11 | 611820 | AKAP9 | |
| LQT12 | 601017 | SNTA1 | |

1. A method for identifying genes comprising: a) a population of athletes with a particular injury; and b) a population of athletes that did not have said injury; c) comparing said populations in a Genome-wide association study (GWAS).

2. A method for rehydrating an athlete, said method comprising: a) determining the genotype of said athlete for at least one gene associated with salt retention or salt-sensitive blood pressure; and b) administering a rehydration fluid based on the determined genotype.

3. The method of claim 2, wherein the determined genotype is based upon a polymorphism in a cytochrome P450 gene associated with salt retention.

4. The method of claim 3, wherein said P450 gene is CYP3A5.

5. The method of claim 3, wherein said P450 gene is selected from the group consisting of CYP11B1 and CYP11B2.

6. The method of claim 2, wherein said gene associated with salt-sensitive blood pressure is the angiotensinogen gene.

7. The method of claim 2, wherein the rehydration fluid is prepared by mechanically releasing a calibrated amount of sodium into an aqueous component in a drinking vessel.

8. The method of claim 2, further comprising measuring urinary sodium excretion and systolic blood pressure in said athlete.

9. A method for conditioning an athlete, said method comprising: a) determining the genotype of said athlete for at least one gene associated with a predisposition to injury; and b) preparing a pre-habilitation regimen, wherein the pre-habilitation regimen is selected based on the determined genotype.

10. The method of claim 9, wherein the determined genotype is based upon the COL5A1 gene associated with ACL rupture.

11. The method of claim 9, wherein the determined genotype is based upon the COL1A1 gene associated with ACL rupture.

12. The method of claim 9, wherein the determined genotype is based upon the COL12A1 gene associated with ACL rupture.

13. The method of claim 9, wherein the determined genotype is based upon the genes from the Matrix metalloproteinase (MMP) gene family which is associated with Achilles tendinopathy.

14. The method of claim 13, wherein said MMP gene is MMP3.

15. The method of claim 9, wherein the determined genotype is based upon a combination of genes from the Matrix metalloproteinase (MMP) gene family and the COL5A1 gene which are associated with Achilles tendinopathy.

16. The method of claim 9, wherein the determined genotype is based upon the TNC gene which is associated with Achilles tendon injury.

17. The method of claim 9, wherein the determined genotype is based upon the APOE gene associated with deleterious effects of head trauma.

18. The method of claim 17, wherein said APOE gene is ApoE4.

19. The method of claim 17, wherein said APOE gene is ApoE2.
